(19) United States
(12) Patent Application Publication
(10) Pub. No.: US 2004/0202052 A1
(43) Pub. Date: Oct. 14, 2004

(54) Electronic jewelry with downloadable images

(76) Inventor: Eitan Lev, Even Yehuda (IL)

Correspondence Address: Eitan Lev, 12 Ayelet Hashahar st., Even Yehuda, 40500, IL

(21) Appl. No.: 10/816,425

(22) Filed: Mar. 30, 2004

Related U.S. Application Data
(60) Provisional application No. 60/460,981, filed on Apr. 8, 2003.
(60) Provisional application No. 60/490,618, filed on Jul. 25, 2003.

(51) Int. Cl. G04B 19/00

(52) U.S. Cl. 368/76

(57) ABSTRACT

A system, comprising of a consumer device having processing capabilities and incorporating communication means, and an ornament comprising of: a microprocessor, a memory for storing digital image data, a display for displaying selected image data from the memory, a receiver for receiving image data and storing it in the memory, and a battery for energizing the microprocessor, the display and the receiver; wherein a dedicated application in the consumer device is used for creating and changing images and animations, and then transmitting them to the ornament via a transmitter incorporated in the consumer device. The images and animations are stored in the ornament memory for viewing them on the ornament display when desired, and according to received control data. Said consumer device may be a cellular phone, a personal computer, a PDA and such.

### CROSS-REFERENCE TO RELATED APPLICATIONS

This application claims the benefit of U.S. Provisional Patent Application No. 60/460,981, filed Apr. 8, 2003. This application further claims the benefit of U.S. Provisional Patent Application No. 60/490,618, filed Jul. 25, 2003. Both of these prior applications are assigned to the assignee of the present patent application and are incorporated herein by reference.

### BACKGROUND OF THE INVENTION

1. Field of the Invention

The present invention relates generally to electronic jewelry, capable of viewing images and animations in an electronic display, and particularly to a system and a method for downloading various images and animations to such electronic jewelry directly from an electronic consumer device, or from a server connected to the electronic consumer device.

2. Description of Related Art

During the last few years, electronic jewelry became more and more popular. Unlike traditional jewelry, electronic jewelry incorporating light emitting, color changing and controlled components such as LEDs can produce dynamic effects, thus being more eye-catching.

In the prior art, several patents describe jewelry items, such as pendants or watches, based on electrically controlled and generated light and color effects.

U.S. Pat. No. 6,238,084 describes a wristwatch, comprising of a liquid crystal display, and a detachable bezel, wherein replacing the bezel causes a change of images appearing on the liquid crystal display.

U.S. Pat. No. 20,020,070,688 describes, among other consumer products a pendant, having a set of LEDs, controlled to change the order and the color of lighting.

The electronic jewelry items described in the prior art do not benefit from the rich world of image data already existing for consumer devices such as personal computers and cellular phones, and the capabilities of these consumer devices to receive, change and create images and animations.

Cellular phones become powerful almost as personal computers. The world of cellular communication brings more and more services, besides the traditional voice services: it offers web surfing through the cellular phone, download of ring tones, images and even short videos; built in organizers, and communication means to computers via data cables, infra red and blue tooth technology.

Actually, the cellular phone has become an ornament by itself. Theoretically, it might be used as a pendant, displaying downloaded animations or images; practically, its basic functionality still requires dimensions that make it uncomfortable and heavy as a pendant.

Personal computers are used for several years for connection to the Internet, and specifically for searching for and downloading image data to the PC hard disk, or to other devices. Such consumer device that can download data from a personal computer is the MP3 player, capable of playing music compressed in MP3 format.

### BRIEF SUMMARY OF THE INVENTION

The present invention provides an electronic ornament having the ability to download image data from a consumer device such as a cellular phone, or a personal computer, thus easily enabling an electronic ornament owner to download images and animations created by him, or received from network libraries. The electronic ornament of the present invention gives a person the ability to express himself in a dynamic manner; Its specific goal of the electronic ornament makes it compact enough to be useful and comfortable as an ornament; the connection to a consumer device, makes it very easy for the ornament owner to download new up-to-date images and animations.

Unlike the electronic jewelry described in the prior art and existing in the market, the electronic jewelry provided by the present invention provides a novel way to bring the richness of images and animations already existing in the world of personal computers and cellular phones to the world of jewelry.

The present invention describes a system, where images and animations stored in content servers are transmitted in a compressed form via a network to a “mediator”—a cellular phone or a computer. After received by the mediator, they are decompressed to a set of images, which are sent to the electronic ornament, or first processed according to the user's directions and only afterwards sent to the electronic ornament. In this way, the existing high processing power of cellular phones and PCs is used to produce complicated animations, and the electronic ornament only stores the uncompressed images and displays them. This data flow enables the electronic ornament to be a cheap device, basically composed of memory, display and power supply.

The electronic ornament can be simple and cheap as described above, or can be more sophisticated. A sophisticated electronic ornament can incorporate user interface for producing user control signals to manage its operation. Such sophisticated electronic ornament is also capable of receiving compressed images, decompress them and alter their size or view.

Another aspect of the present invention is providing the cellular services providers on one hand, and animations creators on the other hand, a new business opportunity.

Firms and organizations may also promote their products or ideas by using the present invention. In this case, users may download the animations for free, and the promoters will pay per download.

It should be noticed, that the present invention might be used not only as jewelry but also for other purposes, such as an identification tag.

It is a principal object of the present invention to provide a system, comprising of a consumer device having processing capabilities and incorporating communication means, and an ornament comprising of: a microprocessor, a memory for storing digital image data, a display for displaying selected image data from the memory, a receiver for receiving image data and storing it in the memory, and a battery for energizing the microprocessor, the display and the receiver; wherein a dedicated application in the consumer device is used for creating and changing images and animations, and then transmitting them to the ornament via a transmitter incorporated in the consumer device. The images and animations are stored in the ornament memory for viewing them on the ornament display when desired, and according to received control data. Said consumer device may be a cellular phone, a personal computer, a PDA and such.

It is still another object of the present invention to provide a system comprising of the consumer device and the ornament described above, and a server storing animations and images, said server able to get control signals and send data in response to control signals to consumer device via a cellular network. Said network may be a cellular network in case the consumer device is a cellular phone, and may be IP based network in case the consumer device is a personal computer. The consumer device owner activates an application in the consumer device to receive images and animations from the server via the network according to specified criteria; and after the images and animations are received by the consumer device, the user activates this application to optionally edit or alter these images, using image processing techniques, and transmits the images and animations from the consumer device to the ornament via the transmitter. It should be noticed that there might be an interactive session between the consumer device and the server, before the images are transmitted to the ornament.

Additional features and advantages of the invention will become apparent from the following drawings and description.

It should be noticed, that although the following drawings and description describe an electronic ornament shaped as a pendant, the electronic ornament of the present invention could be shaped also as a necklace, an earring, a bracelet etc.

### BRIEF DESCRIPTION OF THE DRAWINGS

The present invention will be understood and appreciated more fully from the following detailed description, taken in conjunction with the drawings in which:

FIG. 1 schematically illustrates an electronic ornament, shaped as a pendant, in accordance with the present invention.

FIG. 2 shows a cross-section of the upper part of the pendant of FIG. 1.

FIG. 3 shows a cross-section of the lower part of the pendant of FIG. 1.

FIG. 4 shows a view of the sides of the pendant of FIG. 1.

FIG. 5 shows a view of the bottom of the pendant of FIG. 1.

FIGS. 6 and 7 are schematic block diagrams of the main modules comprising the pendant of FIG. 1, and of the pendant's interfaces. FIG. 6 relates to a “sophisticated” pendant capable of storing compressed images and animations and decompressing them, and also capable of managing the timing of viewing the stored data. FIG. 6 relates to a “simple” pendant, capable of storing uncompressed images and controlling only the timing of the viewing image.

FIG. 8 schematically illustrates a method for connecting the pendant of FIG. 1 to a cellular phone, via a dedicated interface.

FIG. 9 is a schematic flow diagram illustrating the data flow in a system comprising a content server, a cellular phone and the pendant of FIG. 1.

FIG. 10 is a schematic flow diagram illustrating the data flow in a system comprising a content server, a personal computer and the pendant of FIG. 1.

FIG. 11 is a schematic flow diagram illustrating the main modules in the system described at FIG. 9.

FIG. 12 is a schematic flow diagram illustrating the data flow of producing in the cellular phone an animation based on images downloaded from a content server.

FIG. 13 is a schematic flow diagram illustrating the data flow of producing in the cellular phone an animated text, with embedded symbols.

FIG. 14 is a schematic flow diagram illustrating the data flow of producing an animation based on selected images, within the content server.

FIG. 15 is a schematic flow diagram illustrating the data flow of producing an animation based on photos taken by a camera embedded in the cellular phone.

FIG. 16 is a schematic flow diagram illustrating the data flow of producing an animation based on a set of animations downloaded from the content server.

FIG. 17 is a schematic flow diagram illustrating the data flow of receiving an animation sent by an owner of another cellular phone.

FIG. 18 is a schematic flow diagram illustrating the data flow of animation personalization.

FIGS. 19-21 are flow diagrams illustrating processes in a system wherein the pendant is a “sophisticated” pendant, as described above.

FIG. 19 is a schematic flow diagram illustrating the data flow of downloading an animation to the pendant using a cellular phone.

FIG. 20 is a schematic flow diagram illustrating the data flow of downloading an animation to the pendant using a personal computer.

FIG. 21 is a schematic flow diagram illustrating the data flow of selecting an animation to view from a set of animations stored in the pendant memory.

FIG. 22 schematically illustrates a method for connecting the pendant of FIG. 1 to a personal computer, via a dedicated cradle.

FIG. 23 is a schematic flow diagram illustrating the data flow of downloading an animation to the pendant from a memory card holding animations, using the dedicated cradle of FIG. 22.

FIG. 24 is a schematic flow diagram illustrating the data flow of selecting an animation to view from a set of animations stored in the pendant memory.

FIG. 25 schematically illustrates a pendant, which can be attached to a cellular phone and become an integral part of it.

### DETAILED DESCRIPTION OF THE INVENTION

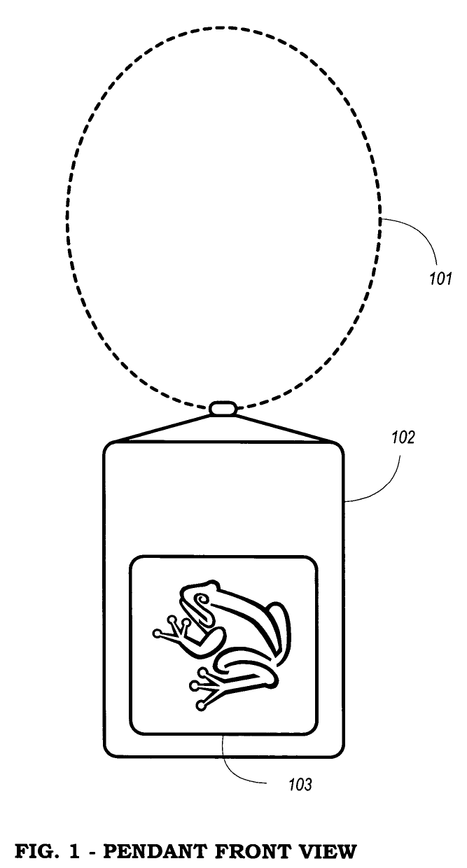

FIG. 1 schematically illustrates a pendant, in accordance with the present invention. The pendant is comprised of a chain 101, a case 102 containing electrical circuit and a display 103, such as LCD, receiving signals from the electrical circuit and continuously viewing animations or images produced according to said signals. The case also holds a regular battery, or a rechargeable battery, for activating the electrical circuit. The pendant incorporates communication means, for downloading data to produce animations or images to be presented on the display. The pendant may also incorporate user interfaces such as buttons to control the pendant's operation.

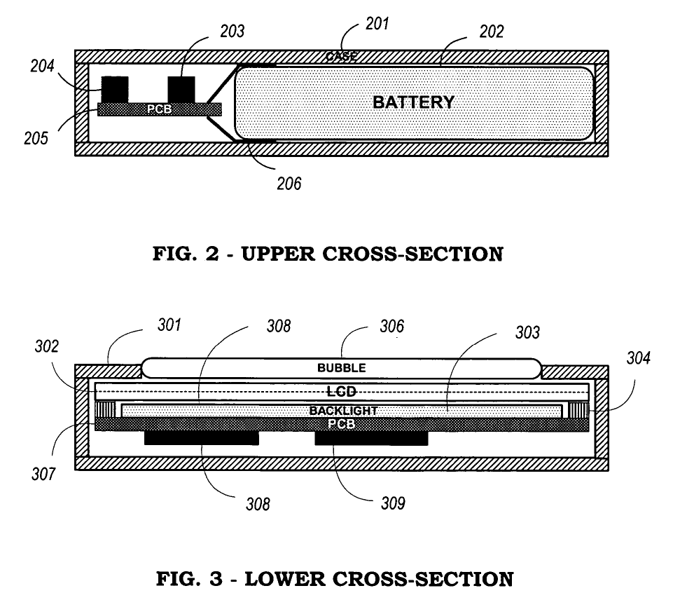

FIG. 2 and FIG. 3 are cross-sectional views of the pendant, describing the main electrical elements inside the pendant.

FIG. 2 schematically illustrates a cross-sectional view of the top of the pendant. Pendant case 201 incorporates a battery 202, for operating the electrical circuit. Electronic components 203 and 204 are assembled on PCB 205, and metal contacts 206 are used for electrically contacting the battery to the electrical circuit.

FIG. 3 schematically illustrates a cross-sectional view of the bottom of the pendant. Pendant case 301 incorporates LCD, comprising of the LCD glass 302, LCD backlight 303, and contacts 304 for passing signals from PCB 307 to the LCD glass. Bubble 306 covers the LCD glass to protect it from damage. PCB 307 lies under the LCD, and is a continuation of PCB 305 shown in FIG. 2. It integrates electronic components 308 and 309.

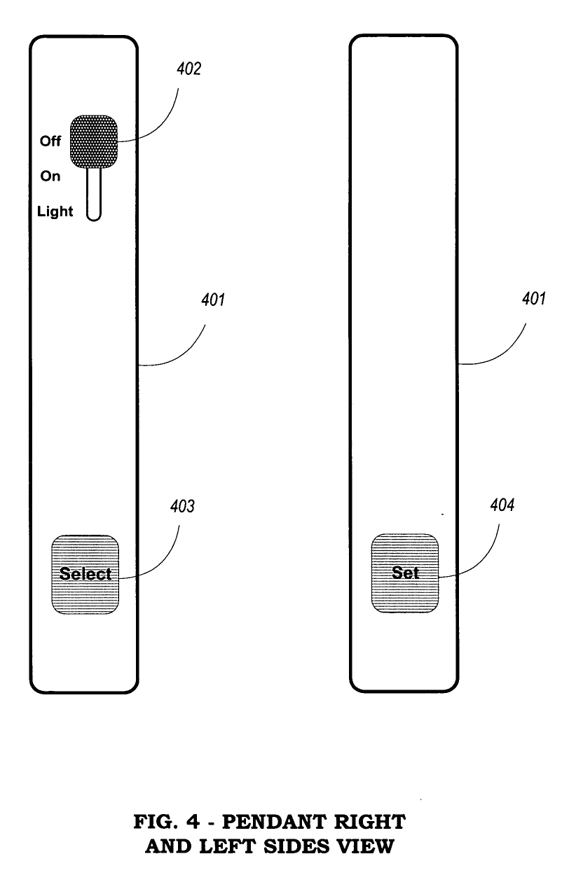

FIG. 4 schematically illustrates buttons and slides, optionally located in the sides of the pendant's case 401, for controlling its operation. Slide 402 has three modes: “Off”, “On” and “Light”. When “Off” mode is selected, the pendant is inactive. When “On” mode is selected, the pendant is operating. When “Light” mode is selected, the pendant is operating, and its display backlight is also operating.

Button 403 is the “Select” button. It is used to select an image or an animation from a set of animations stored in the pendant memory. Button 404, the “Set” button, is used for setting a selected animation to be displayed.

It should be noticed that the user interface could vary from the one described in FIG. 4, and could be operated in other methods.

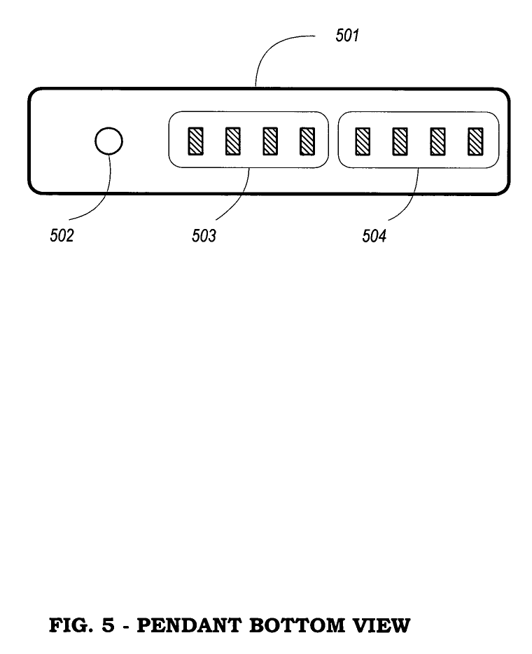

FIG. 5 is a view of the bottom of the pendant case 501. Connection 502 is for charging the rechargeable battery inside the case. Elements 503 and 504 are two sets of metal contacts, for communicating up to two separate devices, as will be explained in details later.

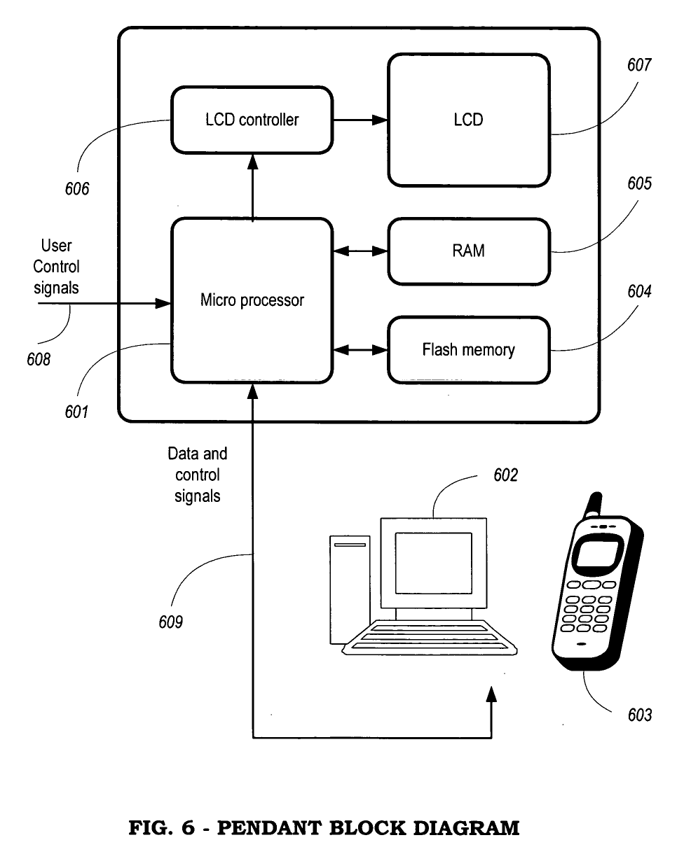

FIG. 6 is a schematic block diagram including the main modules comprising a “sophisticated” version of the pendant of FIG. 1, and its interfaces to images and animations sources.

Microprocessor 601 is responsible for managing the whole process and for controlling the rest of the modules. It is connected via interface 609 to external devices, such as a personal computer 602 or a cellular phone 603, where the interface carries data and control signals between the pendant and the external devices. It may be noticed that the interface can be based on a cable, Infrared, blue tooth, WiFi or other types of connection methods.

Microprocessor 601 stores animations received via interface 609 in flash memory 604. The animations are in a compressed format, requiring a limited amount of memory for storing each of them, typically several tens of Kbytes. The compression may be in various formats, such as GIF, JPEG and others.

Several types of animations, such as abstract animations, may also be represented as several sets of commands, each set for one image. When a command is executed it may direct the processor to create geometrical shapes in defined colors, move a shape created in the previous image to a new position inside the current image, or hold the presentation of the current image for a defined period of time.

Flash memory 604 also holds the pendant application, executed by the microprocessor to achieve the full functionality of the pendant.

When a specific animation is selected for display, microprocessor 601 de-compresses the compressed animation, and stores the de-compressed images in RAM 605. If a set of animations is selected for continuous display, the de-compressed images are stored one after the other in RAM 605. If the animation is in a “set of commands” format, the microprocessor produces the set of images comprising the animation, and stores them in RAM 605.

During the mode of periodical display of animations, the images are retrieved from RAM 605 by the microprocessor, and are sent to LCD controller 606. The fact that the animation is decompressed only once at the beginning of its periodical display, saves battery power and enables a longer time of usage for each battery charge.

LCD controller 606 produces signals according to the images data sent by microprocessor 601, causing LCD 607 to view the required image.

User control signals received via interface 608 may direct the processor to change its mode of operation, for instance start viewing stored animations one after the other, or start viewing the current animation in a periodical manner.

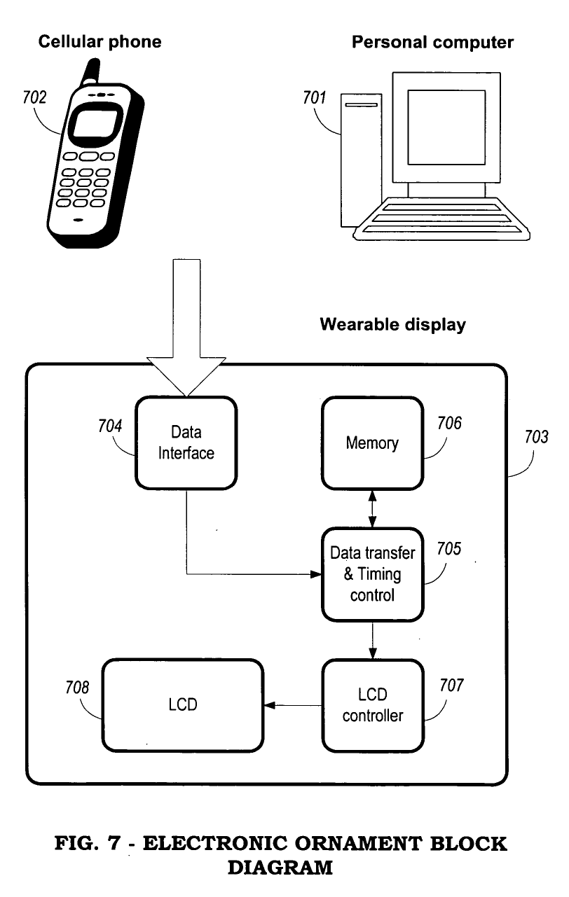

FIG. 7 is a schematic block diagram including the main modules comprising a “simple” version of the pendant of FIG. 1.

Personal computer 701 and Cellular phone 702 may send uncompressed images to electronic ornament 703. The images are received through data interface 704 of the electronic ornament. Another type of data received by the electronic ornament may be timing data, defining the order and display time period of the images. Data transfer & timing control module 705 has two functionalities: store the received images at memory 706, according to their predefined order; and retrieve the images from memory 706 for sending them to LCD controller 707, according to the timing data.

LCD controller 707 produces signals according to the images data sent by Data transfer & timing control module 705, causing LCD 708 to view the required images.

It should be noticed that Data transfer & timing control module 705 can be a microprocessor with limited functionality, or any kind of logic component such as ASIC or FPGA.

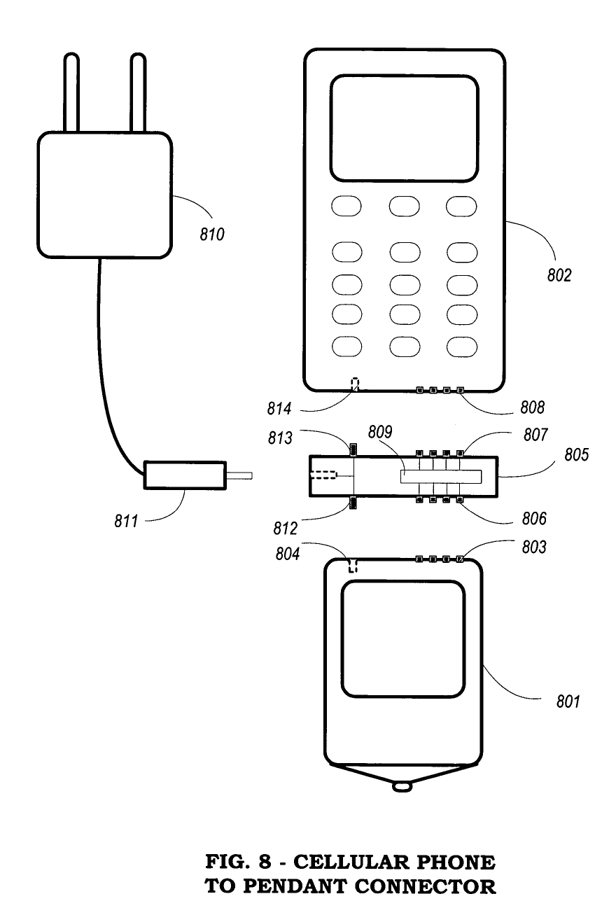

FIG. 8 schematically illustrates a method for connecting the pendant of FIG. 1 to a cellular phone, via a dedicated interface.

In order to receive data from cellular phone 802, pendant 801 has a set of metal contacts 803, capable of receiving data and transferring it to microprocessor 601 of FIG. 6. Pendant 801 also incorporates connector 804, for charging its rechargeable battery from an external power source.

Connector 805 is responsible for bi-directional communication between pendant 801 and cellular phone 802, and for charging both pendant 801 and cellular phone 802. Connector 805 incorporates for the communication purpose two sets of contacts, set 806 coupled to contacts 803 of the pendant and set 807 coupled to contacts 808 of cellular phone 802. Contacts 806 and 807 are also coupled inside connector 805, directly or via converter 809 and are used to convert, if required, the signals received from the cellular phone to the type of signals used by the pendant, and vice versa.

Connector 803 is coupled to electricity source via transformer 810 and connector 811. The power is directed to connector 812, coupled to connector 804 of pendant 801, and to connector 813 coupled to connector 814 of cellular phone 802.

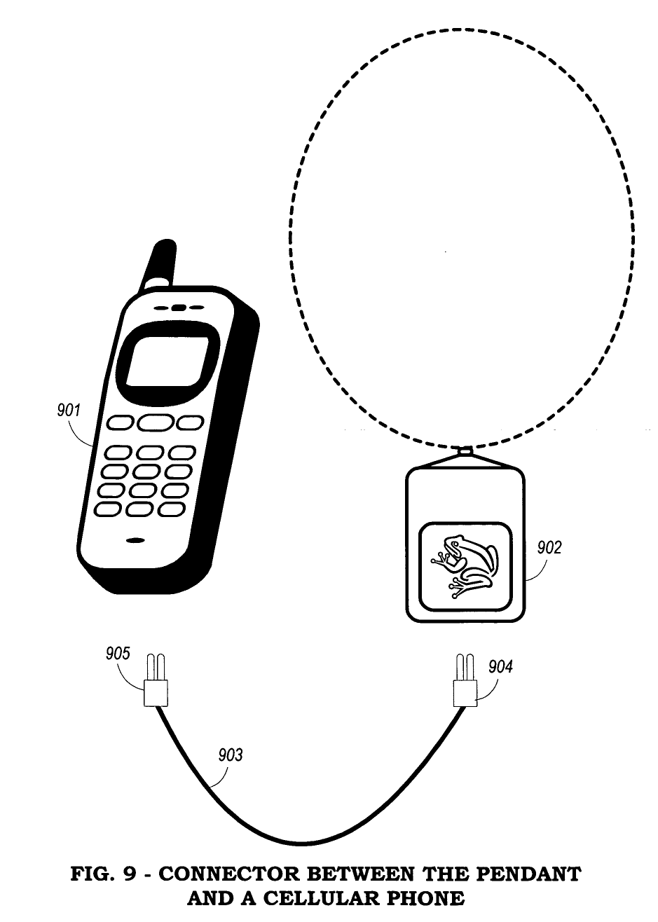

FIG. 9 schematically illustrates another method for connecting the pendant of FIG. 1 to a cellular phone, via a dedicated interface.

Pendant 902 receives data from cellular phone 901 via cable 903. The same connector may be also used to charge pendant 902 by coupling it to the charging circuitry of cellular phone 901. Connectors 904 and 905 are dedicated connectors, part of their pins used to pass data, and the rest for charging the pendant.

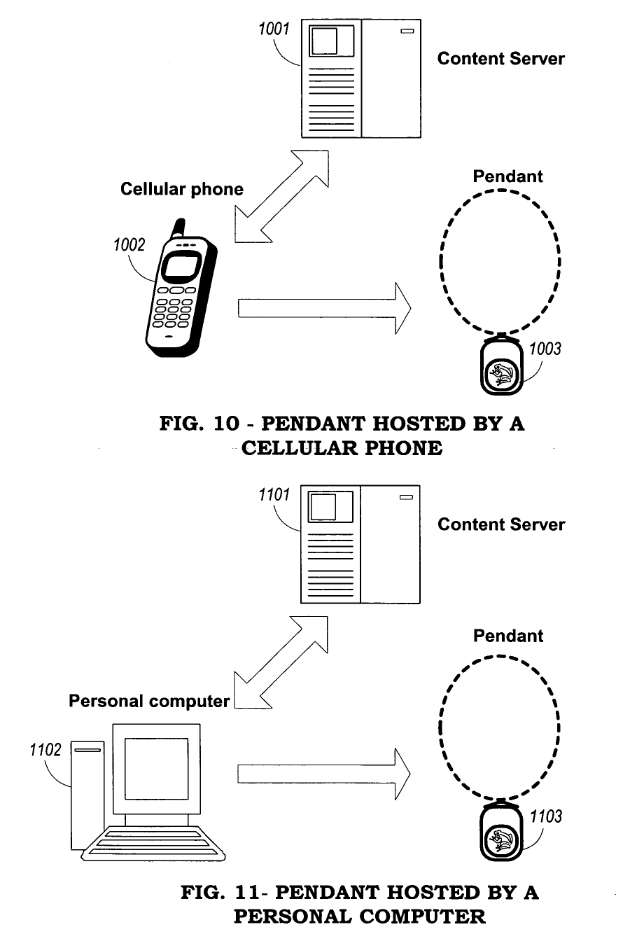

FIG. 10 is a schematic flow diagram illustrating the data flow in a system comprising a content server, a cellular phone and an electronic ornament.

In such system, content server 1001 stores a database of categorized compressed images and animations. Cellular phone 1002 may contact content server 1001 via the cellular network, and retrieve a set of images and/or animations, their attributes or their minimized versions. After retrieving the images or the animations, cellular phone 1001 decompresses them, and may also perform image-processing actions according to the user's selection, to create a new animation. The set of uncompressed images is then sent to electronic ornament 1003 via any type of communication means such cable, IR or blue tooth.

FIG. 11 is a schematic flow diagram illustrating the data flow in a system comprising a content server, a personal computer and an electronic ornament.

The system described at FIG. 11 is similar to the system described at FIG. 10, where personal computer 1102 takes the role of cellular phone 1002 of FIG. 10. Personal computer 1102 may communicate with content server 1101 via the Internet or any other network. The communication of personal computer 1102 with electronic ornament 1103 may be done via any of the communication means mentioned regarding FIG. 10.

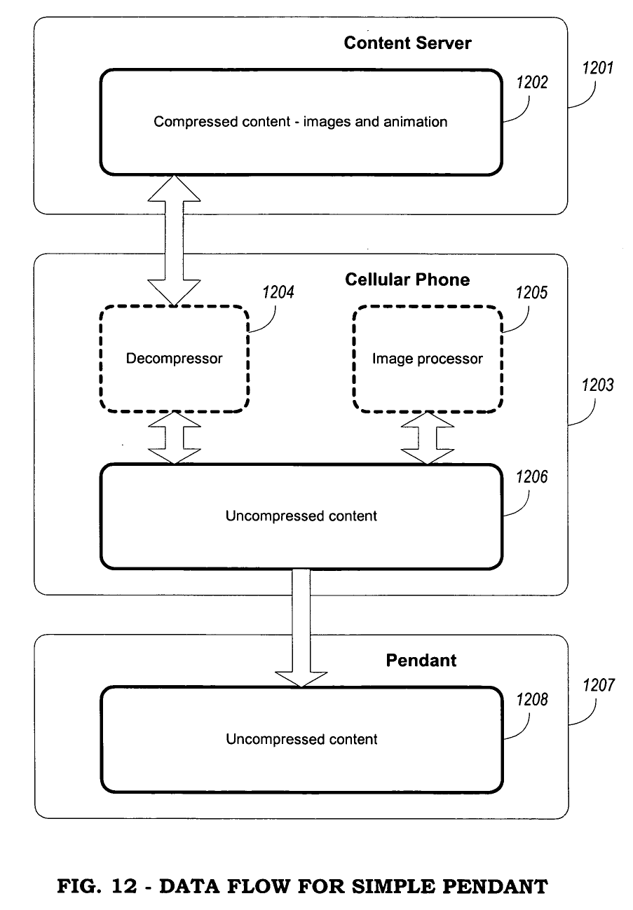

FIG. 12 is a schematic flow diagram illustrating in more details the data flow at the system described at FIG. 10.

Content server 1201 holds a database 1202 of compressed images and animations. As mentioned above, it may also store attributes of these images and animations, and minimized versions of them.

Following the interaction of the cellular phone owner with the application at content server 1201, cellular phone 1203 receives a set of images and/or animations. First they are decompressed at de-compressor 1204. Afterwards, the images may be sent to memory 1206 and then to electronic ornament 1207. The user may also perform image-processing algorithms to produce a new animation from the original set of images and/or animations. The images composing the new animation are also sent to memory 1206, and then via one of the communication means described above, to electronic ornament 1207.

Uncompressed images received at electronic ornament 1207 are stored at memory 1208, and sent to the LCD controller to produce viewable images.

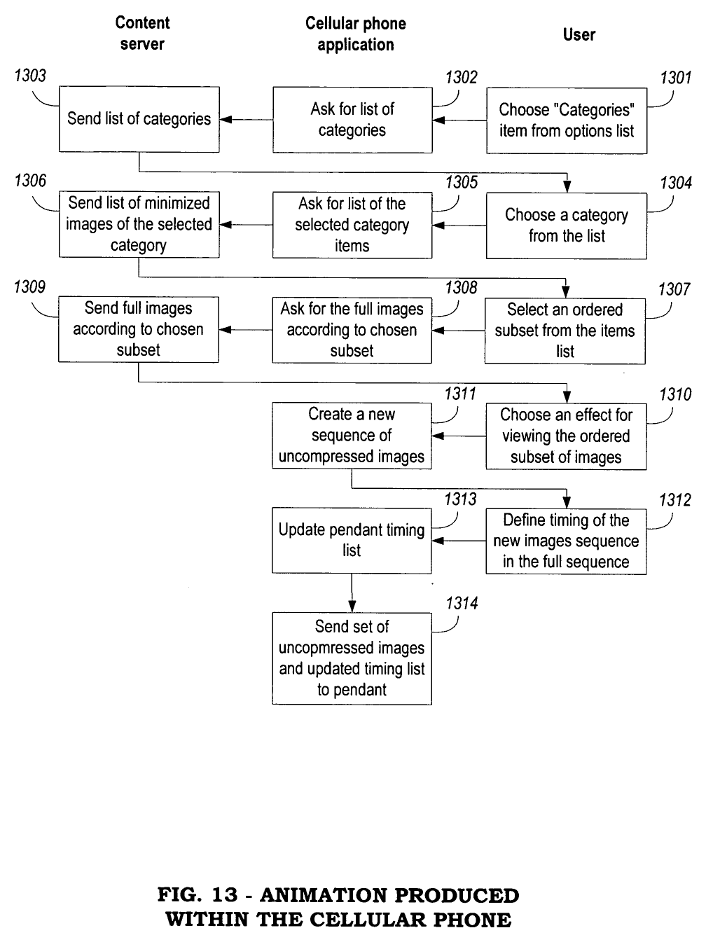

FIG. 13-19 are a set of schematic flow diagrams illustrating possible data flows in the system described at FIG. 10. These flow diagrams describe the actions of the owner of a cellular phone and an electronic ornament, and how they influence the applications residing at the cellular phone and the content server.

FIG. 13 is a schematic flow diagram illustrating the data flow of producing an animation based on images downloaded from a content server to a cellular phone.

The user first activates the “Electronic jewelry” application (“the application”) residing at the cellular phone. Then he chooses the “Category” item at an options list viewed to him by the application (block 1301). The application contacts the content server and asks for an updated list of animations and images categories (block 1302). The content server transmits as an answer the list of categories names (block 1303).

The user chooses a category from the list, specifying that he is interested in images (block 1304), and the application asks the content server for a list of the images contained in the chosen category (block 1305). The content server transmits a set of minimized relevant images (block 1306). The user then selects a subset of the viewed images (block 1307); the application asks the content server for the full images of the selected subset (block 1308). The content server returns the required set of images (block 1309).

The user then selects in the application an effect from a list of possible effects. This effect defines the way the chosen images will be replaced one by the other. Such effects may be fade, dissolve, swivel and so on (block 1310). The user may also define the period of time each image will appear until replaced by the next image. The application activates the image-processing module to create an animation with the required effect (block 1311).

The “Electronic jewelry” application at the cellular phone also manages the sequencing and timing of the set of images stored in the memory of the electronic ornament. The user can view the current sequence (“Timing list”) of the stored animations and their timing, and choose when to schedule the new animation within that sequence (block 1312). The user may also define how many times the animation will be repeated, and define an idle time between two consequent animations, for power saving purpose. The application updates the timing list of the electronic ornament (block 1313), and sends the set of produced images and the updated timing list to the electronic ornament (block 1314).

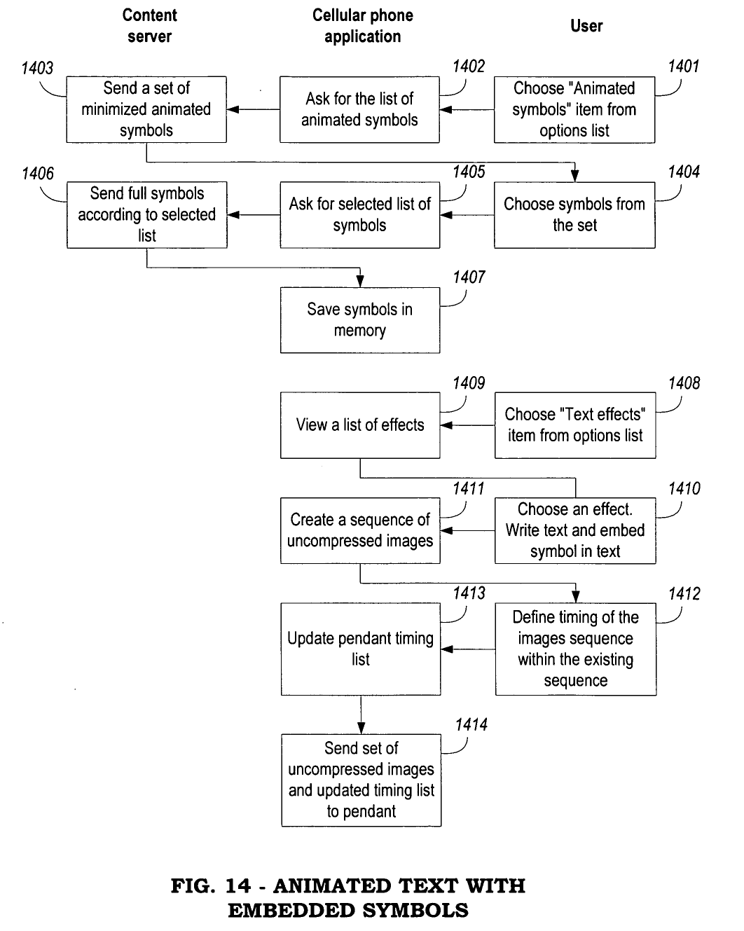

FIG. 14 is a schematic flow diagram illustrating the data flow of producing an animation based on a phrase written by the user, and a symbol embedded in it. An example for it may be the phrase “I love NY”, where the word “love” is expressed by a symbol (image or animation) of a heart.

The user first activates the “Electronic jewelry” application at the cellular phone. Then he chooses the “Animated symbols” item at an options list viewed to him (block 1401). The application contacts the content server and asks for a list of animated symbols (block 1402). The content server transmits as an answer a set of minimized relevant symbols (block 1403). The user chooses a subset of the viewed symbols (block 1404); the application asks the content server for the full images or animations of the selected subset (block 1405). The content server returns the required set of compressed images or symbols (block 1406), and they are saved in the memory of the cellular phone (block 1407).

Later on, the user activates again the “Electronic jewelry” application at the cellular phone. Then he chooses the “Text effects” item at an options list viewed to him (block 1408). The application views to him a list of possible effects, such as “wave” etc. (block 1409); The user chooses a desired effect, writes a phrase and embed a symbol from the set of symbols stored earlier in the memory of the cellular phone (block 1410).

The application activates the image-processing module to create an animation with the chosen effect (block 1411). The user updates the timing list of the electronic ornament (block 1412). The application saves this update (block 1413), and sends the set of produced images and the updated timing list to the electronic ornament (block 1414).

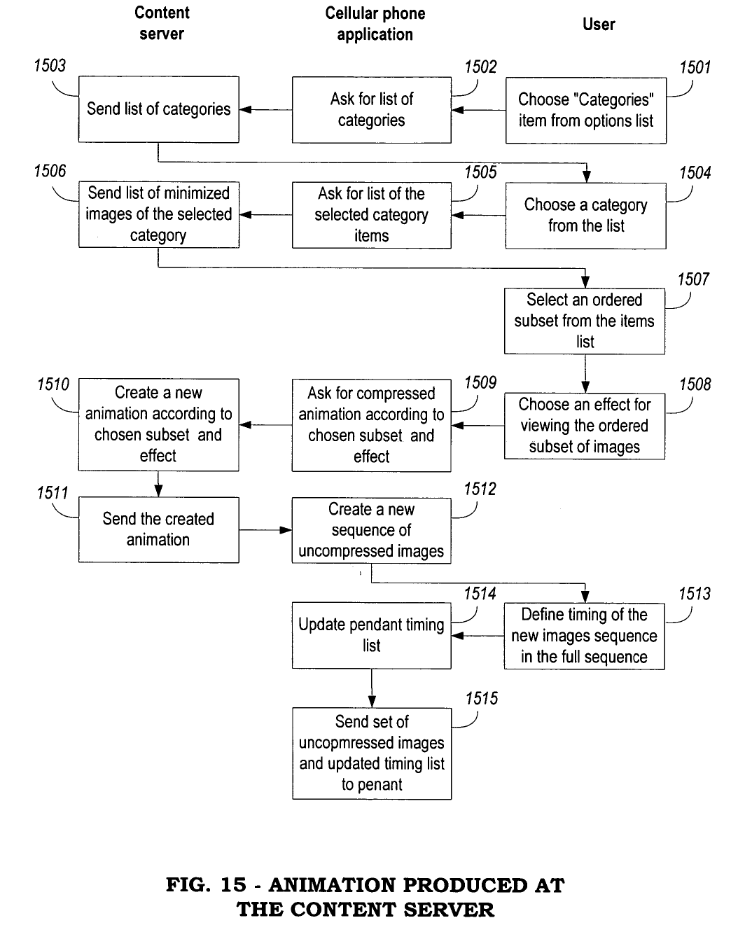

FIG. 15 is a schematic flow diagram illustrating the data flow of producing an animation by the content server, based on images stored in the database of the content server, according to the definitions of the user.

The initial steps are much alike the steps described for FIG. 13. The user first activates the “Electronic jewelry” application at the cellular phone. Then he chooses the “Category” item at an options list viewed to him (block 1501). The application contacts the content server and asks for an updated list of animations and images categories (block 1502). The content server transmits as an answer the list of categories names (block 1503).

The user chooses a category from the list (block 1504), and the application asks the content server for a list of the items contained in the chosen category (block 1505). The content server transmits a set of minimized relevant images (block 1506), and the user then selects a subset of the viewed images (block 1507).

The user then selects in the application an effect from a list of possible effects (block 1508). Unlike in the flow diagram of FIG. 13, the image processing is taking place in the content server. The application sends to the content server the subset of selected images and the chosen effect. An image-processing module within the content server creates a compressed animation due to the chosen images and effect (block 1510), and transmits it to the cellular phone (block 1511).

The application decompresses the compressed animation (block 1512). The user updates the timing list of the electronic ornament (block 1513). The application saves this update (block 1514), and sends the set of produced images and the updated timing list to the electronic ornament (block 1515).

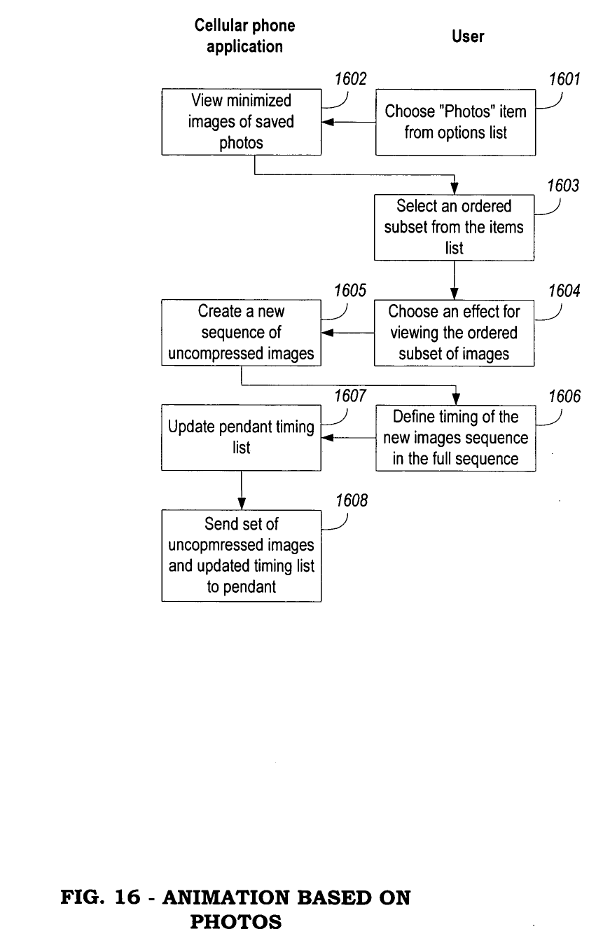

FIG. 16 is a schematic flow diagram illustrating the data flow of producing an animation, based on photos that were taken by the owner of a cellular phone having an integrated camera.

In this case, the content server is not part of the process. The user activates the “Electronic jewelry” application at the cellular phone and chooses the “Photos” item at an options list viewed to him (block 1601). The application views to the user a set of minimized photos that were saved before by the user in the memory of the cellular phone (block 1602). The user chooses an ordered list of photos (block 1603), and the required transition effect (block 1604). The application activates the image-processing module to create an uncompressed animation with the required effect (block 1605). The user updates the timing list of the electronic ornament (block 1606). The application saves this update (block 1607), and sends the set of produced images and the updated timing list to the electronic ornament (block 1608).

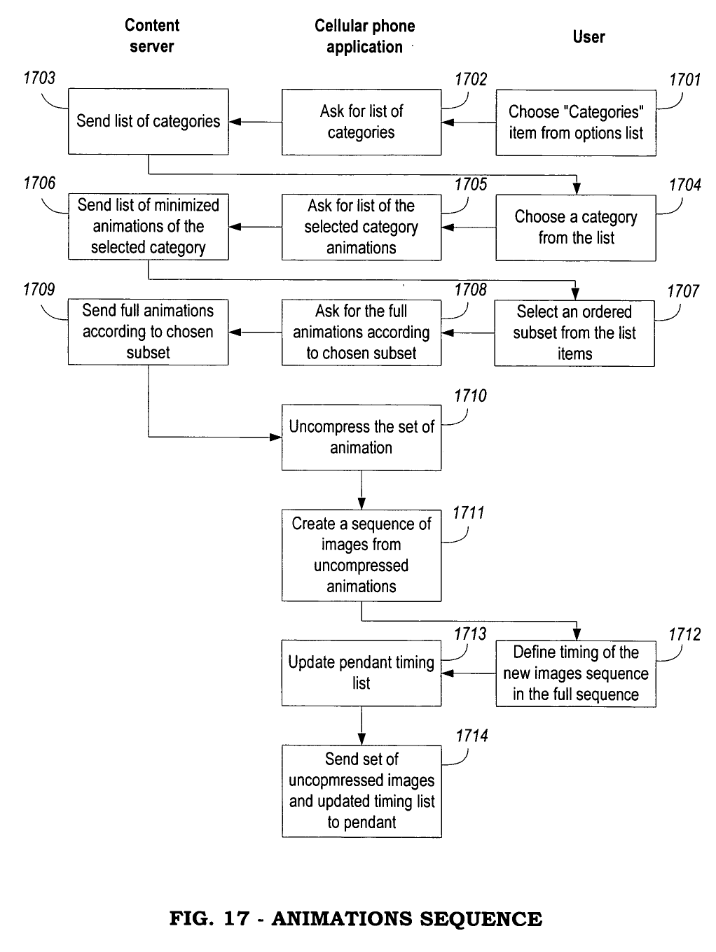

FIG. 17 is a schematic flow diagram illustrating the data flow of producing an animation based on a set of animations downloaded to a cellular phone from a content server.

The user first activates the “Electronic jewelry” application at the cellular phone. Then he chooses the “Category” item at an options list viewed to him (block 1701). The application contacts the content server and asks for an updated list of animations and images categories (block 1702). The content server transmits as an answer the list of categories names (block 1703).

The user chooses a category from the list (block 1704), and the application asks the content server for a list of animations contained in the chosen category (block 1705). The content server transmits a set of minimized relevant animations (block 1706). The user then selects a subset of the viewed animations (block 1707); the application asks the content server for the full animations of the selected subset (block 1708). The content server returns the required set of images (block 1709).

The application decompresses the received set of animations to one sequence of images (block 1710-1711). The user updates the timing list of the electronic ornament (block 1712). The application saves this update (block 1713), and sends the set of produced images and the updated timing list to the electronic ornament (block 1714).

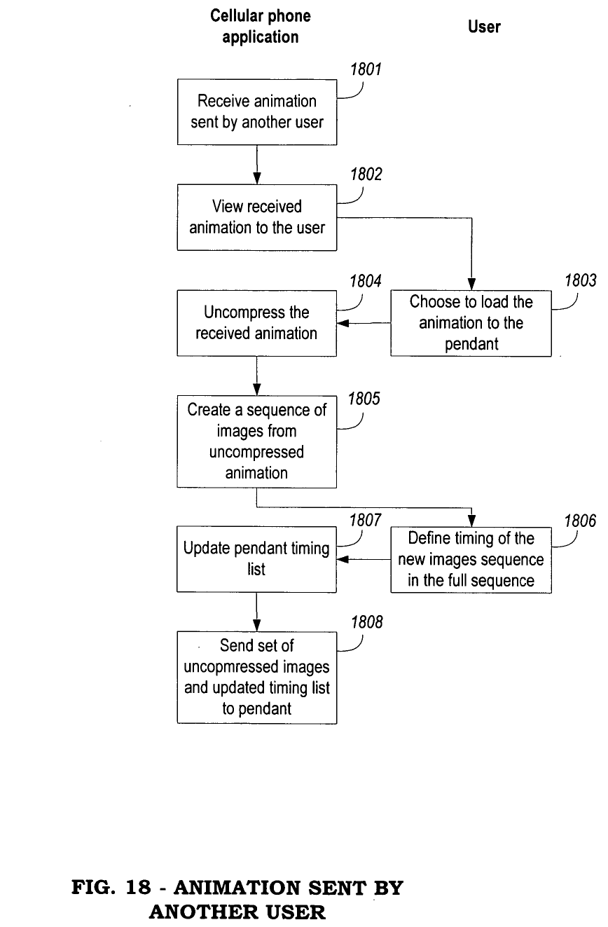

FIG. 18 is a schematic flow diagram illustrating the data flow of receiving an animation from another owner of a cellular phone, and transmitting it to the electronic ornament.

The cellular phone updates the application that it received a new animation sent by another cellular phone (block 1801). The application views the animation to the user (block 1802), to decide if he wishes to download the animation to the electronic ornament. If the user decides to load the animation (block 1803), the application decompresses the received animation (block 1804), and creates a set of images (block 1805) to be downloaded by the electronic ornament. The user updates the timing list of the electronic ornament (block 1806). The application saves this update (block 1807), and sends the set of produced images and the updated timing list to the electronic ornament (block 1808).

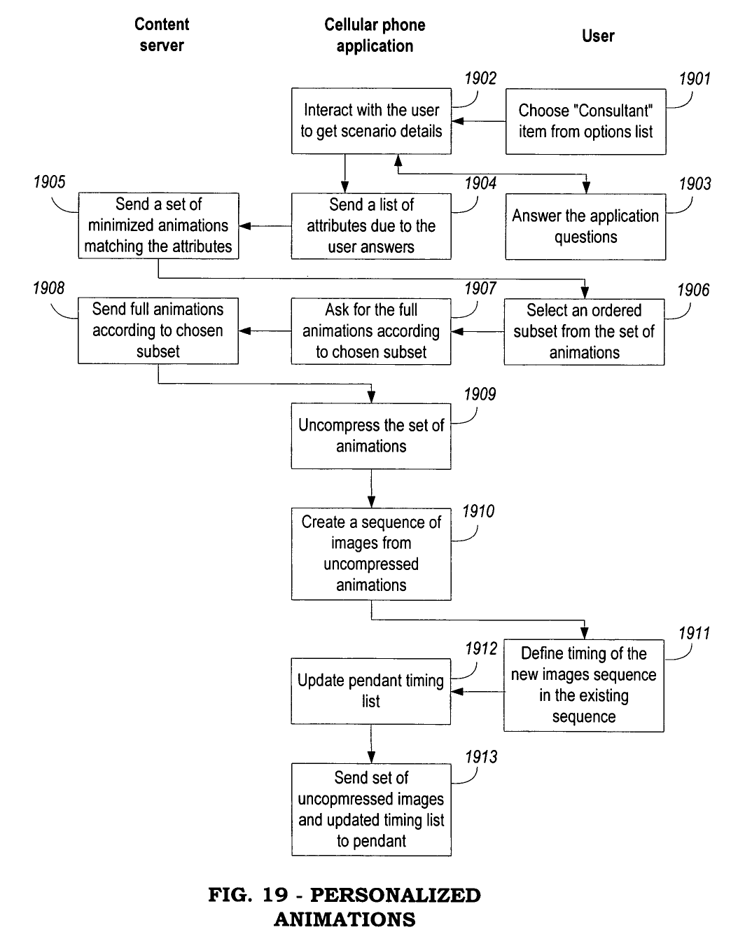

FIG. 19 is a schematic flow diagram illustrating the data flow of a process where a user is being recommended what animation to download to the electronic ornament for a specific occasion.

The user activates the “Electronic jewelry” application at the cellular phone, and chooses the “Consultant” item at an options list viewed to him (block 1901).

The application interacts with the user, guiding him to supply details such as the type of the occasion, what the user plans to wear in that occasion and so on (block 1902). After the user answers these questions (block 1903), the application sends to the content server a list of attributes reflecting the answers of the user (block 1904).

The database at the content server also holds a set of attributes logically connected to each of the images and animations stored in it. When the application request is received, its attributes are matched to the attributes stored at the database of the content server; a set of minimized animations is prepared for the set of animations which their attributes match the attributes of the request and this set is sent back to the application (block 1905).

The user then selects a subset of the viewed images (block 1906); the application asks the content server for the full images of the selected subset (block 1907). The content server returns the required set of images (block 1908).

The application decompresses the received set of minimized animations to a sequence of images (block 1909-1910). The user updates the timing list of the electronic ornament (block 1911). The application updates the timing list of the electronic ornament (block 1912), and sends the set of produced images and the updated timing list to the electronic ornament (block 1913).

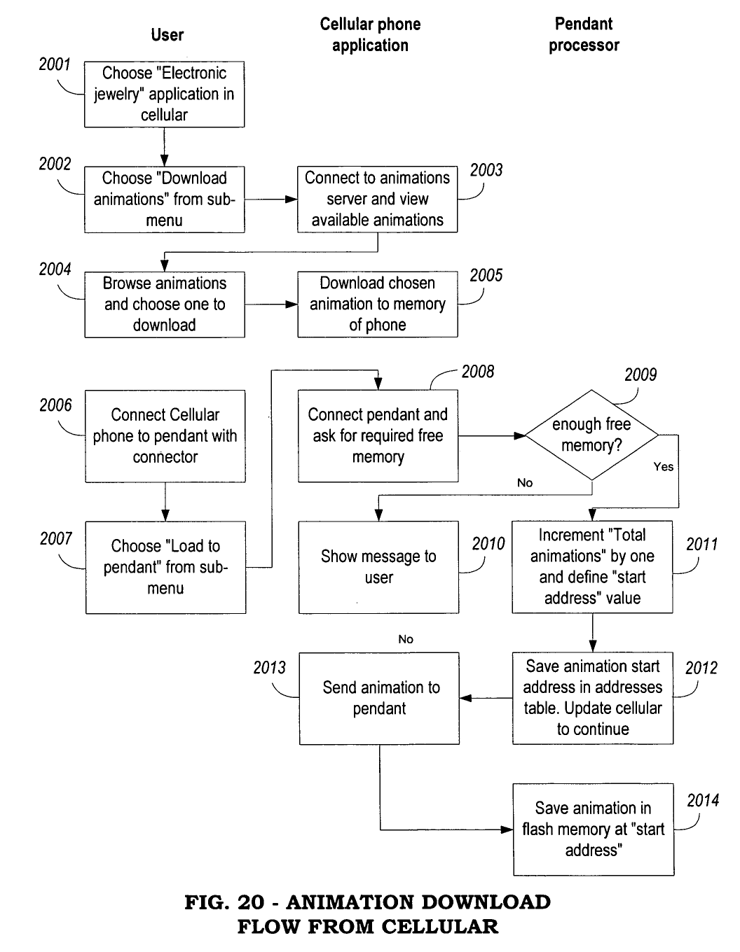

FIG. 20 is a schematic flow diagram illustrating the data flow of downloading an animation to a “sophisticated” pendant using a cellular phone. It focuses on operations made by the processor of the cellular phone and by microprocessor 601 of the pendant.

As described in block 2001, the user initializes the process by choosing the item “Electronic jewelry” application from the set of applications available to him in his cellular phone. It is assumed that this application is loaded into the cellular phone memory over the air, or pre-loaded by the cellular service provider.

The cellular phone views a menu of possible actions, regarding the chosen “Electronic jewelry” application. The user selects “Download animations” from the menu (block 2002).

The processor of the cellular phone, via the equipment of the cellular service provider, establishes a connection to a dedicated server, holding a large set of animations. The animations may be viewed in the cellular phone display by categories, by icons and so on (block 2003). This technique of connecting cellular phones to the Internet and other networks is well known and in use for several time.

The user then browses the animations viewed on the display of the cellular phone, and selects the one he wants to download (block 2004).

The processor of the cellular phone receives the user request, and downloads the selected animation to the cellular phone memory (block 2005). Other mechanisms of the cellular service provider, such as a billing mechanism may be involved, crediting the user for the download action.

When the user wishes to download the animation stored in the cellular phone memory to the pendant, he should first connect the cellular phone to the pendant via the dedicated connector 805 of FIG. 8 (block 2006). Then the user chooses in the “Pendant animations “menu the item “Load to pendant” (block 2007).

When receiving the user's request, the cellular phone processor connects the pendant microprocessor 601 via connector 805, and asks if there is enough space in flash memory 604 of the pendant for the requested animation (block 2008).

Microprocessor 601 of the pendant checks if there is enough memory in flash memory 604; If there is not enough memory, a negative answer is returned to the cellular phone processor (block 2009). The cellular phone processor views on the display of the cellular phone a message saying so (block 2010), and the user will have to free some memory by removing an older animation.

If there is enough free memory, Microprocessor 601 increments by one the “Total animations” register which keeps an updated total amount of animations. Microprocessor 601 also activates a process defining an address in flash memory 604 where the animation can be stored (block 2011). Preferably, the process keeps a contiguous memory space for each animation, to avoid memory segmentation issues.

The start address of the animation in flash memory 604 is saved by microprocessor 601 in “Start addresses” table (block 2012). “Start addresses” table is sequential, and the start address of an animation can be retrieved from it by the animation index. Then, a positive answer is returned to the cellular phone processor, and the cellular phone processor sends the stored animation to the pendant microprocessor 601 via connector 705 (block 2013). The animation is stored at the defined address (block 2014).

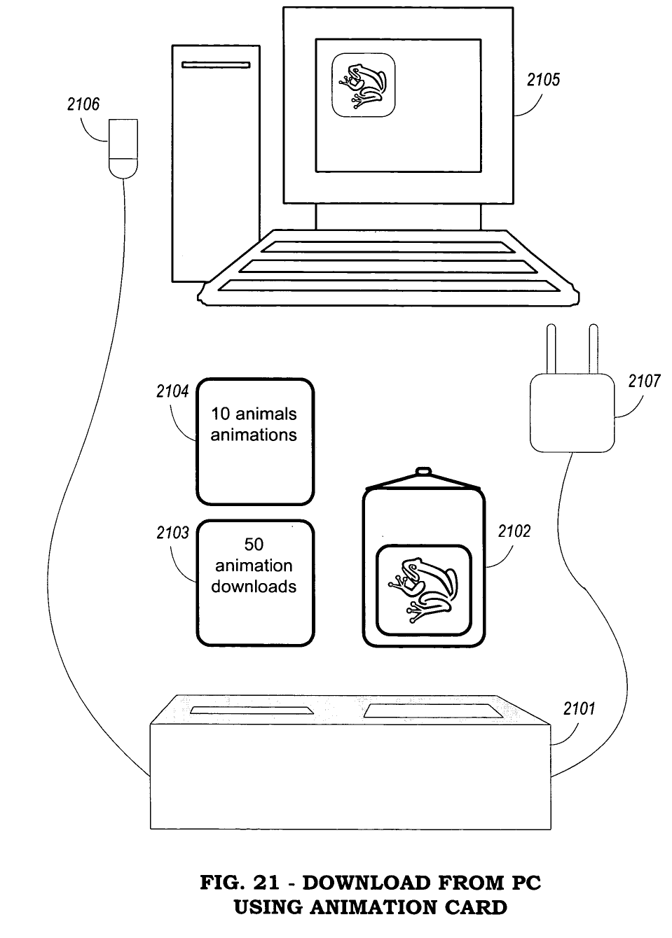

FIG. 21 schematically illustrates a method for connecting the pendant of FIG. 1 to a personal computer 2105, via a dedicated cradle 801.

Cradle 2101 has two slots—one slot for holding pendant 2102, and the second slot for holding either memory card 2103 or memory card 2104.

Cradle 2101 may also include some electronic circuit, used to convert signals transferred between pendant 2102 and personal computer 2105. Connector 2106 is a standard connector used in personal computers, such as USB connector. Transformer 2107 supplies power to the cradle for charging pendant 2102, and for operating the cradle electrical circuit, if exists.

When pendant 2102 is inserted into the matching slot of the cradle, its microprocessor 601 is capable of contacting both the personal computer 2105 and an inserted memory card, via contact sets 303 and 304 located at the bottom of pendant 2102.

Memory card 2103 holds a unique code number, and is used to allow a pre-defined number of actions of downloading animations to pendant 2102. Pendant 2102 is capable of retrieving this code number from memory card 2103 via the cradle circuit and sending it to personal computer 2105. Personal computer 2105 is connected via the Internet to a dedicated server, storing images and animations data and managing download operations. Said server, decides according to the received unique code number if the download of the animation should be allowed or denied.

Memory card 2104 holds a set of animations. When inserted into the matching slot of the cradle, microprocessor 601 can contact it via the circuit of the cradle, and move the stored animation to flash memory 604 of the pendant.

Microprocessor 601 can distinguish between the two types of memory card by a specific contact in the set of contacts located on the cards, which is electrically set to “0” in one type of the cards, and to “1” in the other type. Reading this value directs microprocessor 601 how to react.

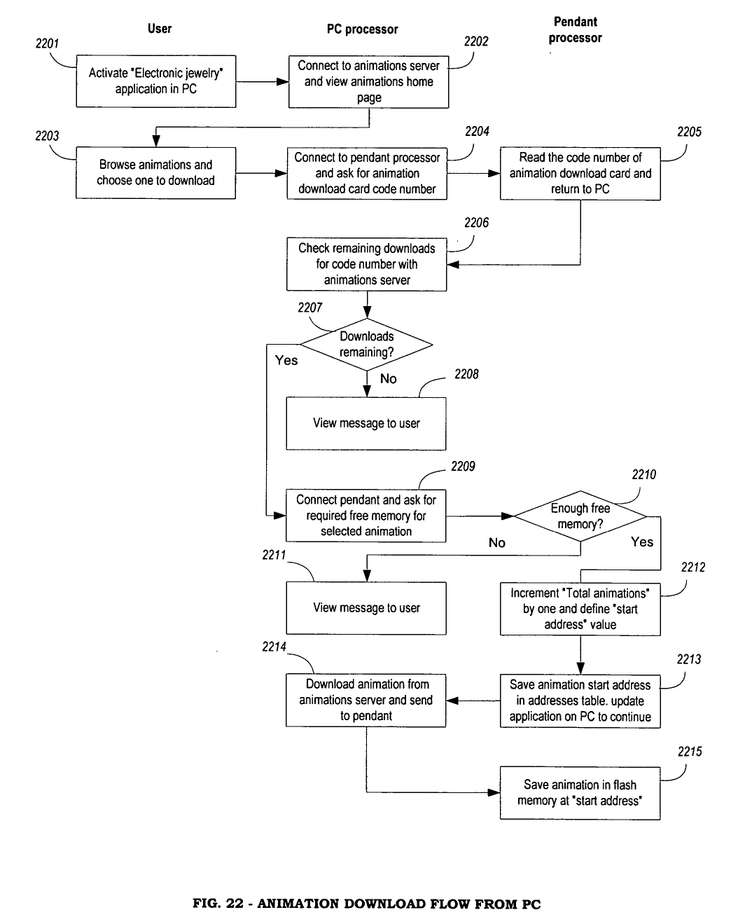

FIG. 22 is a schematic flow diagram illustrating the data flow of downloading an animation to the pendant using a personal computer. This flow diagram is much alike the previous one illustrated at FIG. 20.

A preliminary action for this flow diagram is the installation of a “Electronic jewelry” application in the personal computer. This application is capable of contacting via a network an “Animations server”, holding the animations as files, animation cards code numbers, a billing system and other related data. The application can view to the user animations stored in the “Animations server” memory, so the user will be able to specify the animations he would like to download.

The “Electronic jewelry” application is also capable of contacting a pendant microprocessor 601 via connector 2106 of the cradle 2101. As mentioned before, the connection is bidirectional and is used for data transfer and for control as well.

The “Electronic jewelry” application may also include an animation editor, where the user is able to create animations of his own, for downloading them to the pendant.

As described in block 2201, the user initializes the process by activating the “Electronic jewelry” application previously installed in the personal computer.

The application establishes a network connection to the “Animations server”, and views its home page on the display of the personal computer (block 2202).

The user then browses the animations viewed on the display of the personal computer, and selects the one he wants to download (block 2203).

When receiving the user's request, the “Electronic jewelry” application connects pendant microprocessor 601 via connector 2106, and asks for a code number of an animation download card 2103 (block 2204).

Microprocessor 601 of the pendant reads via the circuit of cradle 801 the code number of an inserted animation download card, and sends it back to the “Electronic jewelry” application (block 2205).

The “Electronic jewelry” application on the personal computer sends the code number to the “Animations server”. The last one checks how many downloads are still available for this code number. If there are any, the “Animations server” sends a download confirmation to the “Electronic jewelry” application, and decrements by one the number of remaining downloads for this code number; If no downloads remained, or the code number is invalid, it returns a negative answer (block 2206).

The “Electronic jewelry” application checks the answer (block 2207): if it was negative, a proper message is viewed to the user on the personal computer display (block 2208); If the answer was positive, the “Electronic jewelry” application asks microprocessor 601 to check if there is enough free memory space for storing the new animation (block 2209).

Microprocessor 601 checks if there is enough memory in flash memory 604 (block 2210); if there is not enough memory, a negative answer is returned to the “Electronic jewelry” application. The application views on the display of the personal computer a message saying so (block 2211), and the user will have to free some memory by removing an older animation.

If there is enough free memory, Microprocessor 601 increments by one the “Total animations” register which keeps an updated total amount of animations. Microprocessor 601 also activates a process defining an address in flash memory 604 where the animation can be stored (block 2212). Preferably, the process keeps a contiguous memory space for each animation, to avoid memory segmentation issues.

The start address of the animation in flash memory 604 is saved by microprocessor 601 in “Start addresses” table (block 2213). A stored animation start address can be retrieved from the “Start addresses” table by its index. Then, a positive answer is returned to the “Electronic jewelry” application. The application downloads the required animation from the “Animations server”, and sends it to pendant microprocessor 601 (block 2214). The animation may be optionally saved on the local disk of the personal computer, for backup purposes. The animation is received by microprocessor 601 and stored at the defined address of flash memory 604 (block 2215).

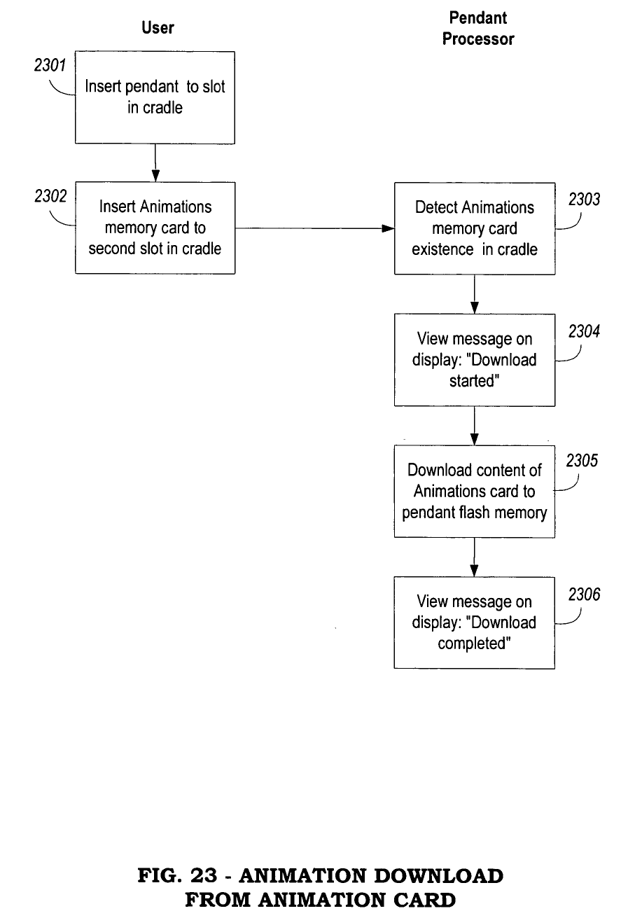

FIG. 23 is a schematic flow diagram illustrating the data flow of downloading an animation to the pendant from a memory card holding animations.

The user first inserts the pendant into its matching slot in cradle 2101 (block 2301). Then the user inserts animations memory card 2104 to its matching slot in cradle 2101 (block 2302).

Pendant microprocessor 601 periodically detects the existence of animations memory card 2104 in its matching slot (block 2303). When the card is detected, pendant microprocessor 601 views a message on the pendant's display 607: “Download started” (block 2304), and downloads the whole content of the animations memory card to the flash memory of the pendant 604. An interactive process may be in use at this stage asking the user if he agrees to remove old animations to free space for new ones, if required (block 2305).

At the end of the process, pendant microprocessor 601 views a message on the pendant's display 607: “Download completed” (block 2306).

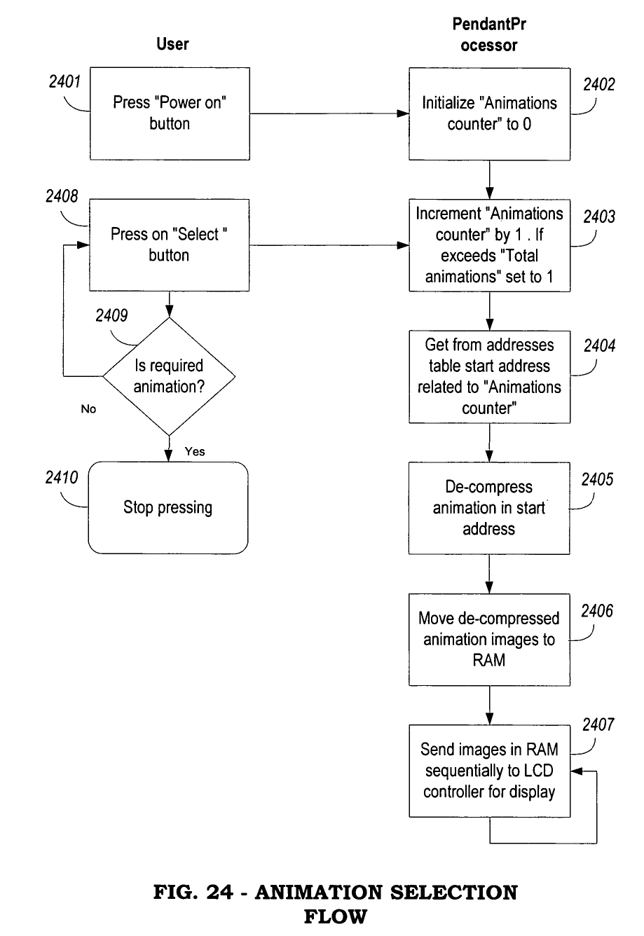

FIG. 24 is a schematic flow diagram illustrating the data flow of selecting an animation to view from a set of animations stored in pendant flash memory 604.

Slide 202 of FIG. 2 is moved from “Off” mode to “On” mode, to activate the pendant circuit (block 2401). Pendant microprocessor 601 initializes register “Animations counter” to zero (block 2402). Register “Animations counter” is then incremented by one; if it exceeds the current value of“Total animations” register, it is set to 1 (block 2403). Microprocessor 601 gets from the addresses table the start address related to the current value stored at “Animations counter” register (block 2404). Then microprocessor 601 reads the animation starting at this start address in flash memory 604, and uses the proper algorithm to de-compress it. A special header may identify the type of the compression with a unique identifier for each type (block 2405).

Microprocessor 601 sends the de-compressed animation to be stored in RAM 605 (block 2406). From now on, Microprocessor 601 periodically sends the animation stored at RAM 605 to LCD controller 606, to be displayed on LCD 607 (block 2407).

As described above, after power startup the pendant will start viewing periodically the first animation stored in flash memory 604. When the pendant's owner wishes to select an animation from the set of stored animations, he should press the select button repeatedly, until he sees the animation he wants on the LCD (blocks 2408-2410). Each press on the button increments “Animations counter” register by one (block 2403), and is followed by the activation of the whole process described in blocks 2403 to 2407.

It should be noticed that the user may control the sequence of viewed animations, the delay between two animations and other viewing parameters by the pendant's buttons and slides, or by other types of user interfaces such as “touch screen” type LCD.

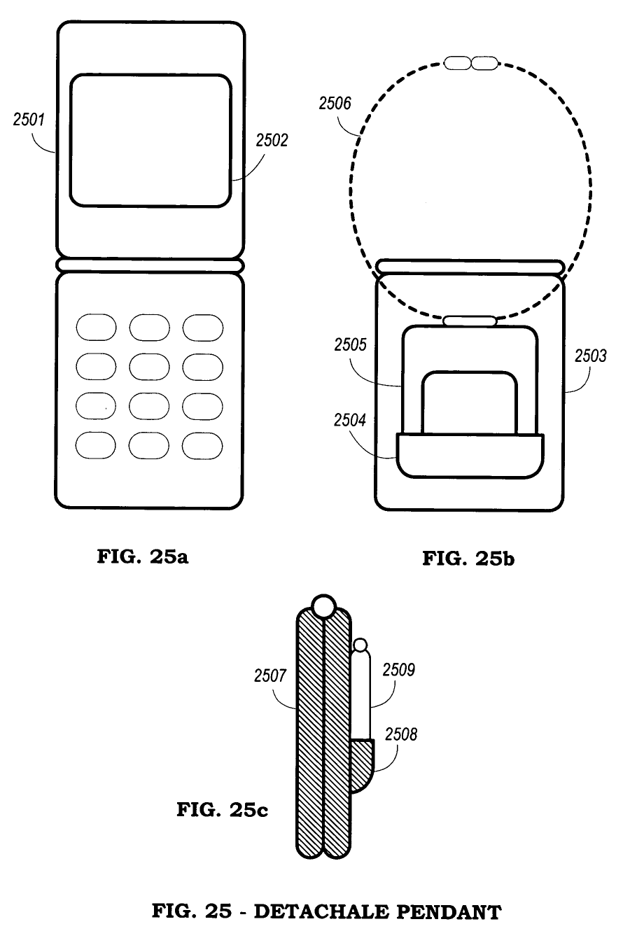

FIG. 25 includes three figures: 25a, 25b and 25c, schematically illustrating a pendant, which can be attached to a cellular phone and become an integral part of it.

In order to eliminate the need for special connector between the pendant and a cellular phone, as described in FIG. 8 and FIG. 9, a dedicated cellular phone can be formed, capable of holding the pendant in a holder, where the holder is an integral part of the cellular phone. Whenever the user wishes to wear the pendant, he should detach the pendant from the cellular phone.

Whenever pendant 2505 is attached to cellular phone 2503, images and animations can be transmitted directly to the pendant when received by the cellular phone from the cellular network, to be stored in the pendant's flash memory. The process of downloading images or animations is much alike the process described in FIG. 20, without the need to use the connector, and without the need to temporarily store the downloaded data in the cellular memory.

When the pendant is attached to the cellular phone, it can be also used as an integral part of the cellular phone for viewing information such as the details of a calling person, or time and date to the user. In this mode, the processor of the cellular phone transmits the relevant data to the processor of the pendant, for viewing it on the LCD.

FIG. 25a is an illustration of a cellular phone 2501, having two folders connected by a hinge. The upper folder incorporates display 2502.

FIG. 25b is a front view of the cellular phone 2503 when closed. Holder 2504 is an integral part of the cellular phone. In its bottom it has a set of connectors, used for passing control signals and data signals between the processor of the cellular phone and the processor of pendant 2505. The connectors inside the holder are also used to charge the pendant's rechargeable battery 202, as described in FIG. 2, while the cellular phone is charged. Necklace 2506 is connected to pendant 2505, also when attached to the cellular phone.

FIG. 25c is a side view of the cellular phone 2507 when closed. Holder 2508 holds pendant 2509, and the pendant becomes an integral part of the cellular phone.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A system for updating the appearance of jewelry, comprising:
an electronic ornament to be worn by a person, having a case including:
processing means, a memory for storing at least one digital image, a display for displaying a selected digital image from said memory, a receiver for receiving said at least one digital image and storing them in said memory, and a battery for energizing said microprocessor, said display and said receiver; and
an electronic consumer device including: processing means, and a transmitter for sending said at least one digital image to said receiver.

2. The system in claim 1, wherein the data received from said electronic consumer device is in a compressed form; said data is stored in said memory and is decompressed by said processing means to one image at least.

3. The system in claim 1, wherein said at least one digital image is a plurality of digital images whose consecutive display forms an animated effect.

4. The system in claim 1, wherein said at least one digital image is a plurality of digital images and said transmitter sends to said receiver also control data to be stored in said memory for defining at least one of the timing, the order and the rate of displaying said plurality of images.

5. The system in claim 1, wherein said case also includes a user interface to control said display.

6. The system in claim 1, wherein said electronic consumer device is a personal computer.

7. The system in claim 1, wherein said electronic consumer device is a cellular telephone.

8. The system in claim 7, wherein said electronic ornament forms a detachable part of said cellular telephone and said display is also operable as a functional screen of said cellular phone.

9. The system of claim 1, further comprising a server for communicating with said electronic consumer device and downloading thereto said at least one digital image.

10. The system of claim 9, wherein said server and said electronic consumer device are communicating over the Internet.

11. The system of claim 9, wherein said electronic consumer device is a cellular telephone, communicating with said server over a cellular network.

12. The system of claim 9, wherein said electronic consumer device is capable of changing said digital images received from said server using image processing techniques.

13. The system of claim 9, wherein said digital images received from said server are in a compressed form; said digital images are decompressed by said electronic consumer device, to be transmitted to said electronic ornament.

14. The system of claim 9, wherein said server activates an application according to control data received from said electronic consumer device, for changing said digital images using image processing techniques; and afterwards transmitting said digital images to said electronic consumer device.

15. The system in claim 9, wherein said server also incorporates a data base for storing digital images and animations with at least one related attribute for each, such that said application in said electronic consumer device is able to receive from said server at least one image or animation which its related attribute matches selection criteria.

16. The system in claim 9, also comprising:
a cradle for holding said electronic ornament, the cradle including a circuitry for electronically coupling the electronic ornament to said electronic consumer device, for downloading digital images to the electronic ornament memory, said circuitry also charging a rechargeable battery of said electronic ornament;
said cradle also capable of holding a memory card, the card electronically producing a code, identifying the card owner to said server for crediting purposes;
said cradle also capable of holding another type of memory card, the card holding digital images or animations in its memory, which said electronic circuit of said electronic ornament can access for reading.

17. A method for updating the appearance of electronic ornament, said electronic ornament incorporating a microprocessor, a memory for storing at least one digital image, a display for displaying a selected digital image from said memory, a receiver for receiving said at least one digital image and storing them in said memory, and a battery for energizing said microprocessor, said display and said receiver; said method comprising:
activating an application in an electronic consumer device, said electronic consumer device incorporating processing means and a transmitter, for creating digital images;
activating said application to transmit said digital images from said electronic consumer device to said electronic ornament via said transmitter;
receiving said digital images by said receiver incorporated in said electronic ornament for storing it in said memory;
and sending said stored digital images to be displayed on said electronic display.

18. The method in claim 17, wherein said case also includes a user interface to control said display.

19. The method in claim 17, wherein said electronic consumer device is a personal computer.

20. The method in claim 17, wherein said electronic consumer device is a cellular telephone.

21. The system in claim 20, wherein said electronic ornament forms a detachable part of said cellular telephone and said display is also operable as a functional screen of said cellular phone.

22. The method in claim 17, further comprising: downloading at least one digital image by said electronic consumer device, said at least one digital image sent by a server communicating with said electronic consumer device.

23. The method in claim 22, wherein said server and said electronic consumer device are communicating over the Internet.

24. The method in claim 22, wherein said electronic consumer device is a cellular telephone, communicating with said server over a cellular network.

25. The method in claim 22, wherein said electronic consumer device is capable of changing said digital images received from said server using image processing techniques.

26. The method in claim 22, wherein said digital images received from said server are in a compressed form; said digital images are decompressed by said electronic consumer device, to be transmitted to said electronic ornament.

27. The method in claim 22, further comprising: activating an application in said server according to control data received from said electronic consumer device, for changing said digital images, using image processing techniques; and transmitting said digital images from said server to said electronic consumer device.

28. The method in claim 22, wherein said server also incorporates a data base for storing digital images and animations with at least one related attribute for each, such that said application in said electronic consumer device is able to receive from said server at least one image or animation which its related attribute matches selection criteria.
